(19) United States
(12) Patent Application Publication
(10) Pub. No.: US 2024/0356388 A1
(43) Pub. Date: Oct. 24, 2024

(54) STATOR EXHIBITING IMPROVED THERMO-ELECTRICAL PROPERTIES AND MOLDING METHOD THEREOF

(71) Applicant: SUMITOMO BAKELITE NORTH AMERICA, INC., COMMERCE TOWNSHIP, MI (US)

(72) Inventors: XIAO QUAN DU, COMMERCE TOWNSHIP, MI (US); PHILIP F. BEESLEY, COMMERCE TOWNSHIP, MI (US)

(73) Assignee: SUMITOMO BAKELITE NORTH AMERICA, INC., COMMERCE TOWNSHIP, MI (US)

(21) Appl. No.: 18/640,383

(22) Filed: Apr. 19, 2024

Related U.S. Application Data
(60) Provisional application No. 63/460,727, filed on Apr. 20, 2023.

(51) Int. Cl. H02K 1/16; H02K 1/02; H02K 3/48; H02K 15/02; H02K 15/12

(52) U.S. Cl. CPC H02K 1/16; H02K 1/02; H02K 3/48; H02K 15/02; H02K 15/12; H02K 2213/03

(57) ABSTRACT

Embodiments of this invention includes a stator exhibiting improved electrical and thermal properties for electrical machines, for example, motors and generators having a number of applications including but not limited to electronic axle (e-axle) used in a variety of automobiles, among others, where the coil temperature of the e-axle during operation is much reduced thus improving the performance of the motor. The stator in accordance of this invention is made by a single molding process using a mesh to separate the metal wires from the body of the stator. Also disclosed and claimed is a method of molding the stator.

### CROSS REFERENCE TO RELATED APPLICATIONS

This application claims the benefit of U.S. Provisional Application No. 63/460,727, filed Apr. 20, 2023, which is incorporated herein by reference in its entirety.

### BACKGROUND OF THE INVENTION

### Field of the Invention

The present invention relates to a stator exhibiting improved electrical and thermal properties for electrical machines, for example, motors and generators having a number of applications including but not limited to electronic axle (e-axle) used in a variety of automobiles, among others, where the coil temperature of the e-axle during operation is much reduced thus improving the performance of the motor. This invention also relates to methods of molding the stator. The invention also relates to fabrication of a rotor and an invertor used in e-axles.

### Description of the Art

It is known in the art that stators are formed from electrical grade steel using a number of molding methods. A commonly occurring problem is to enable a molding of a series of coil assembly between each of a plurality of stator slots. One approach that has been used in the art is to first mold a series of coil assembly between each of the slots and then in a second molding operation insulate the entire stator assembly. Thus making this approach less practical especially for a large scale production of stators, and therefore, there is a need for better improved processes.

Accordingly, it is an object of this invention to provide a stator that is made by a single molding step which dramatically improves manufacturing efficiency and reduces investment cost in large scale production of stators but also provides a stator with improved thermo-electrical properties.

It is also an object of this invention to provide molding process for the production of the stators as disclosed herein.

Other objects and further scope of the applicability of the present invention will become apparent from the detailed description that follows.

### SUMMARY OF THE INVENTION

Surprisingly, it has now been found that a stator assembly as disclosed herein can be readily produced using a mesh dispensed between a plurality of slots across the inner wall of the stator assembly. A metal wire is then wound around the mesh forming a coil and then the entire stator assembly is encapsulated using a molding compound. The stator assembly as described herein exhibits superior electrical properties as well as good thermal properties.

In another embodiment of this invention there is also provided a method for the production of the stator assembly as described herein.

### BRIEF DESCRIPTION OF THE DRAWINGS

Embodiments in accordance with the present invention are described below with reference to the following accompanying figures and/or images. Where drawings are provided, it will be drawings which are simplified portions of various embodiments of this invention and are provided for illustrative purposes only.

FIG. 1 shows a stator body generally made of an electrical steel containing a plurality of slots used in an embodiment of this invention.

FIG. 2 shows a top down view of a portion of slots of FIG. 1.

FIG. 3 shows a mesh inserted into each of the slots in accordance with the practice of this invention.

FIG. 4 shows a top down view of the metal wires, such as, for example, copper inserted into each of a portion of the slots of FIG. 1 in accordance with the practice of this invention.

FIG. 5 shows a cross-sectional view of the slots arranged with a series of metal wires separated by a mesh and/or a molding compound in accordance with the practice of this invention.

FIG. 6 shows another cross-sectional view of the slots with top end of the metal wires are configured in distributed winding in accordance with the practice of this invention.

FIG. 7 shows a portion of the stator assembly fully assembled with the distributed winding in each of the slots in accordance with the practice of this invention.

FIG. 8 shows a cross-sectional view of the slots arranged with a series of metal wires separated by a mesh which is held in place using a molding compound, with an expanded view to the right and bottom. FIG. 8 further shows the entire assembly encapsulated in a molding compound in accordance with the practice of this invention.

FIG. 9 shows an encapsulated stator assembly in accordance with this invention.

### DETAILED DESCRIPTION OF THE INVENTION

As used herein, the articles “a,” “an,” and “the” include plural referents unless otherwise expressly and unequivocally limited to one referent.

Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the term “about.”

Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

As used herein, the expression “electrical steel” means generally a material or product which utilizes the ferromagnetic properties of iron. Generally, electrical steel provides minimum iron loss in addition to high saturation magnetization. Electrical steel is also referred to as “silicon steel,” however, silicon content is generally limited to about three mass percent.

Thus, in accordance with the practice of this invention there is provided a stator assembly comprising:
a plurality of slots across the inner wall of the stator assembly, wherein dispensed a mesh;
a metal wire wound around the fiber mesh forming a coil; and
a molding compound encapsulating the stator assembly.

It is known in the art that the body of the stator assembly is generally made of electrical grade steel. Typically, the stator body is made by pressing stacks of laminated preformed electrical grade steel sheets, which are generally in circular form with the desired number of slots as further described herein. Generally the laminations are cut to their finished shape by a punch and die or, in small quantities, can be cut by a laser, or by electrical discharge machining.

Generally, the stator body contains from about 48 to 96 slots or more. In some embodiments the stator body contains 96 slots. Accordingly, the laminated electrical grade steel sheets are generally preformed with the desired number of slots and of desired dimensions. Typically the thickness of the laminated electrical grade steel ranges from about 0.20 mm to about 0.65 mm and can be up to 2 mm thickness. However, it should be noted that any of the thickness of the electrical grade steel is employed for the desired type of stator assembly as is well known in the art. It should further be noted that any other material which functions similar to electrical steel can also be used to fabricate the stator body. Examples of such materials include various metal alloys known in the art.

Advantageously, it has now been found that the metal wires dispensed in each of the slots can be isolated from the body of the stator assembly by placing a mesh in each of the slots and then inserting the metal wires. Thus, the mesh provides a consistent minimum gap between the electrical steel and the wire for electrical insulation. More advantageously, by practice of this invention it is now possible to mold the stator assembly of this invention in a single molding operation.

The prior art methods required two-step molding operation in that in the first step the metal wires are placed in the slots by first inserting a blade. The blade insertion and controlling the positions of the blade are technically challenging. In addition, for a potting or molding compound to fill such long narrow gap requires high quality particle size control. Then the potted metal wires are molded using any of the methods known in the art. Before such first molding of the metal wires the blades needed to be retracted adding additional complexity. By practice of the present invention manufacturing efficiency is improved by reducing the number of molding steps needed but also provides a stator assembly exhibiting improved thermal and electrical properties. More significantly, the thickness of the insulation layer formed by the molding compound in the slots can be much reduced thereby it is possible to produce stators exhibiting better thermal performance. See for example, PCT Patent Publication No. WO 2021/246216 A1, pertinent portions of which are incorporated herein by reference.

Any of the metal wires that meets the requirements of use in stator assembly can be used. Suitable examples of metal wires include copper, aluminum and the alloys thereof. In some embodiments the metal wire used is a copper wire.

Any of the mesh that will bring about the intended benefit can be used to form the stator assembly in accordance of this invention. The mesh is made of a non-electrically conductive material. As used herein the “mesh” means a strands of a plastic, cellulosic or other flexible or a ductile material, which is in the form of a web or a net that has many attached woven or non-woven strands. A key feature of the mesh as used herein is a non-magnetic and highly thermal conducting property. Non-limiting examples of mesh that can employed are selected from the group consisting of nonwoven mesh, woven mesh, nonwoven plastic mesh, woven plastic mesh, nonwoven glass fabric mesh and woven glass fabric mesh. Specific examples of metallic mesh may include aluminum or aluminum alloys, which are non-magnetic. Examples of plastic mesh include polyester, polyamide or polyimide fibers, among others. Cellulosic mesh can include wood fibers, fibrous paper, and the like. Similarly, mesh made of various glass fibers are known in the art. Additionally, any of the composite materials comprising one or more of the materials described above can also be used as mesh. In some embodiments of this invention the mesh used is a woven or non-woven glass fabric. As noted, the mesh as contemplated herein is an insulating sheet, which can be an insulating paper, an insulating film, a nonwoven fabric, and a mesh cloth as a base material.

Non-limiting examples of suitable insulating sheet/film/fabric that can be used in this invention include without any limitation multilayer laminate (NPN-222, manufactured by Nitto Shinko), aramid fiber (DuPont Teijin Advanced Paper Co., Ltd., Nomex, Type 410), polytetrafluoroethylene (PTFE) mesh (made by Fluorocarbon Industry Co., Ltd., F3261-05, equivalent to 18 mesh), cell strainer (made by Funakoshi, Mini Cell Strainer II, Nylon Mesh 70 μm), polypropylene mesh (Crown net 24 mesh manufactured by Dio Chemical Co., Ltd.), polyester mesh (made by Japan Special Textiles Co., Ltd., TNo. 60SS), polyester mesh fabric (made by Japan Special Fabrics, Super Strong 200 mesh), polyethylene terephthalate mesh sheet (TB30, manufactured by NBC MeshTech), polyethylene terephthalate mesh sheet (PET mesh) (Made by Oki Shoji Co., Ltd., product name: OKILON HYBRID), 100 mesh polyethylene mesh filter (Manufactured by Azwan Co., Ltd., trade name: Polyethylene Mesh), nylon mesh (Manufactured by Daiki Shoji Co., Ltd., trade name “OKILON-Sha 2520”), Weave (Warp/Weft: polyethylene terephthalate monofilament) (L-screen165-027/420PW, manufactured by NBC Meshtech Co., Ltd.), Mesh Silver Black (Silver Black Magic Net (20 mesh, made of polyester) manufactured by Dio Chemical Co., Ltd.), Mesh Gray (PP Gray (24 mesh, made of polypropylene) manufactured by Dio Chemical Co., Ltd.), and so on.

In addition, the mesh provides several other advantages. First, as noted the mesh facilitates the insertion of the metal wires thereby avoiding the use of blades which needs to be removed as is practiced by the prior art. Second, mesh provides a gap between the inner wall of the stator and the metal wire, which is readily controlled. Finally, as it is apparent from the discussions below, the molding compound can readily penetrate the mesh providing excellent solid insulating structure thus enhancing hitherto unattainable mechanical, thermal and electrical properties.

As noted above, in the inner wall of the stator assembly of this invention there is a gap between the slot and the metal wire of at least about 0.1 mm. In some embodiments of this invention there is provided in the stator assembly a gap between the inner wall of the slot and the metal wire from about 0.1 mm to 0.3 mm. The gap is provided to allow for an electrical insulation layer.

Advantageously, the mesh provided in the stator assembly of this invention enables uniform thin wall electrical insulation. At the same time, the mesh enables uniform minimum thermal path and high thermal conductivity.

Finally, the stator assembly is encapsulated by the molding compound. The molding compound penetrates through the mesh and the metal wire thus providing excellent insulation as well as stable structure. Any of the molding compound as used in the art for similar applications can be used to encapsulate the stator assembly of this invention. Non-limiting examples of such molding compound is selected from the group consisting of epoxy resin, epoxy molding compound, inorganic fillers, and a mixture in any combination thereof. The molding compound as used herein is generally an uncured or semi-cured thermosetting resin which can be a solid thermosetting resin at 25° C. or a liquid thermosetting resin at 25° C.

The epoxy resin used in the molding compound as described herein is generally a bifunctional or crystalline epoxy resin such as, for example, a biphenol-type epoxy resin, a bisphenol A-type epoxy resin, a bisphenol F-type epoxy resin, a stilbene-type epoxy resin, and a hydroquinone-type epoxy resin. A novolac-type epoxy resin such as a cresol novolac-type epoxy resin, a phenol novolac-type epoxy resin, and a naphthol novolac-type epoxy resin. A phenol aralkyl-type epoxy resin such as a phenylene skeleton-containing phenol aralkyl-type epoxy resin, a biphenylene skeleton-containing phenol aralkyl-type epoxy resin, and a phenylene skeleton-containing naphthol aralkyl-type epoxy resin. Trifunctional epoxy resin such as a triphenolmethane-type epoxy resin and an alkyl-modified triphenolmethane-type epoxy resin. Modified phenolic-type epoxy resin such as a dicyclopentadiene-modified phenolic-type epoxy resin and a terpene-modified phenolic-type epoxy resin. Examples include a heterocycle-containing epoxy resin such as a triazine nucleus-containing epoxy resin. One of these may be used alone, or two or more may be used in combination.

In some embodiments the epoxy resin comprises one or more epoxy resins selected from the group consisting of a phenol novolac epoxy resin, a phenol aralkyl epoxy resin, and a cresol novolac epoxy resin from the viewpoint of ensuring the fluidity of the resulting resin composition and the strength of the cured product of the molding compound.

Any of the desired amount of the epoxy resin can be employed in the molding compound so as to provide the intended benefit. Generally, such amounts of the epoxy resin in the molding compound may be, for example, 3 mass % or more, 8 mass % or more, 10 mass % or more, 12 mass % or more with respect to the total solid content of the molding compound from the viewpoint of improving the fluidity of the resulting molding compound and improving workability and moldability.

In some embodiments the content of the epoxy resin is 30 mass % or less, or 20 mass % or less with respect to the total solid content of the molding compound from the viewpoint of improving the strength and heat resistance of the cured product formed using the molding compound.

As noted, the molding compound may additionally contain inorganic or organic fillers. By way of examples the inorganic filler may include fused silica such as fused fractured silica and fused spherical silica, silica such as crystalline silica, alumina, aluminum hydroxide, silicon nitride, and aluminum nitride. One of these may be used alone or two or more may be used in combination. The inorganic filler generally contains silica and one or more selected from the group consisting of fractured silica and fused spherical silica from the viewpoint of favoring the mechanical or thermal properties of the cured product of the molding compound.

The maximum diameter of the inorganic filler may be 0.5 mm or less, 0.1 mm or less, or 0.05 mm or less from the viewpoint of favoring the filling of the insulating sheet (i.e., the mesh) into the opening. However, the maximum diameter of the inorganic filler is smaller than the minimum width of the opening of the insulating sheet, for example, 50% or less of the minimum width. When the molding compound is provided in the slot, the molding compound can be filled appropriately without blocking the opening of the insulating sheet by the inorganic filler.

Generally, suitable molding compound that can be employed to encapsulate the stator assembly of this invention exhibits good thermal conductivity which not only withstands the heat generated by the coil but also capable of dissipating the heat. Accordingly, in some embodiments the stator assembly is encapsulated with a molding compound which has a thermal conductivity K1 of a minimum value of about 0.5 W/mK. In some other embodiments the stator assembly is encapsulated with a molding compound which has a thermal conductivity K1 of from about 1 W/mK to about 10 W/mK, from about 2 W/mK to about 9 W/mK, and so on. The lower limit of the thermal conductivity K1 can be 3 W/mK or more, 4 W/mK or more, and so on. The upper limit of the thermal conductivity K1 can be more than 10 W/mK.

Generally, the molding compound also exhibits high thermal properties such that heat resistance performance of the motor embodying the stator assembly of this invention is much improved such that the high output power can be achieved. Accordingly, in some embodiments the stator assembly is encapsulated with a molding compound which exhibits a glass transition temperature (Tg) higher than 150° C.

Further, the molding compound exhibits high compression strength such that the motor encompassing the stator assembly of this invention withstands high loads. Accordingly, in some embodiments the stator assembly is encapsulated with a molding compound which exhibits a compression strength at 25° C. from about 25 kpsi to 40 kpsi.

It is not crucial that the thickness of the molding compound is important but proper insulation should be maintained to ensure it meets the required motor specification for breakdown voltage. Accordingly, in some embodiments the stator assembly is encapsulated with a molding compound having a thickness from about 0.1 mm to about 3.0 mm. The lower limit of the thickness of the molding compound is 0.2 mm or more, 0.4 mm or more, 0.8 mm or more, and so on. The upper limit of the thickness of the molding compound is 2.5 mm or less, 2.0 mm or less, 1.5 mm or less, and so on.

As noted, the stator assembly is generally made of an electrical steel or a metal alloy, which is generally a non-grain-oriented electrical steel and contains from about zero to 6.5 percent silicon. In some embodiments the inner wall of the stator assembly of this invention consists of an electrical steel which is a non-grain-oriented electrical steel containing about 2 percent to about 3.5 percent silicon and has similar magnetic properties in all directions, i.e., it is isotropic. In some other embodiments the inner wall of the stator assembly of this invention consists of a metal alloy which exhibits good magnetic properties. Examples of such metal alloys include electrical steel containing magnesium and/or aluminum, among others.

Another aspect of this invention is that the stator assembly of this invention is provided with an excellent cooling structure. Accordingly, in some embodiments the stator assembly, wherein it enables active cooling on the rotational axis direction side from the coil.

Finally, as it will be appreciated from the specific illustrations of the drawings below, the stator assembly of this invention features a coil that is configured as a distributed winding wound across multiple slots.

In another aspect of this this invention, there is further provided a high productivity one shot molding method of making a stator assembly comprising:
a plurality of slots along the inner diameter of the stator assembly, wherein the slot is a stamped profile;
dispensing within each of the slots a mesh covering the entire surface of the slot;
inserting a progressive winding around the mesh;
forming a winding configuration; and
insulating and encapsulating simultaneously the stator assembly with a molding compound.

Any of the molding methods known in the art can be used to mold the stator assembly as described herein. Examples of such molding methods include transfer mold, injection mold, compression mold, and the like. In some embodiments the molding is carried out by transfer mold method.

The method according to this invention, wherein the stator assembly is made of an electrical steel or a metal alloy as described hereinabove.

The method according to this invention, wherein the mesh is selected from the group consisting of nonwoven mesh, woven mesh, nonwoven plastic mesh, woven plastic mesh, nonwoven glass fabric mesh and woven glass fabric mesh.

The method according to this invention, wherein the molding compound is selected from the group consisting of epoxy resin, epoxy molding compound, and mixtures in any combination thereof.

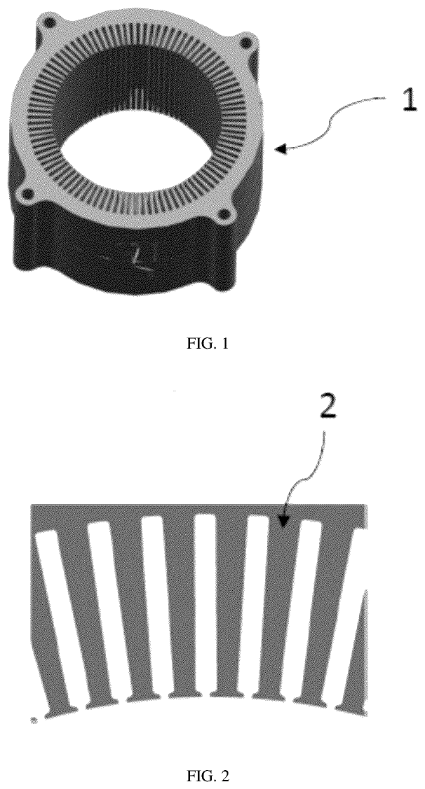

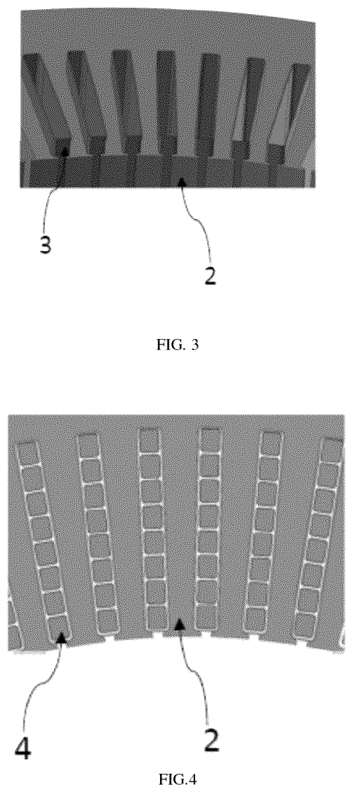

Now, referring to FIG. 1, which illustrates an embodiment of this invention wherein shown a top view of a stator core. As described above, 1 is a stator core formed of a pressed stacks of a laminated electrical steel. For illustration purposes the stator core is shown in the cylindrical form. However, any of the other forms which is commonly used in the art can be used in this invention. FIG. 1 shows a 96 slots stator core, but any of the other stators with lesser or higher number of slots can also be used, such as for example, 48 slots or 72 slots stator. FIG. 2 shows an expanded view of the stator core where the slots are well defined. Each of the slots is separated by a teeth made of electric steel 2. It should be noted that the entire body of the stator is made of electric steel as described above. However, any of the other materials such as metal alloys exhibiting suitable electromagnetic properties can also be employed for this purpose.

FIG. 3 shows a mesh inserted in each of the slots. Any of the mesh as described herein can be used in this step. It should be noted that the mesh 3 is placed evenly inside each of the slots such that there is a gap as described above between the slots and the mesh so as to provide insulation between the inner wall of the stator assembly, which is made of electrical steel 2.

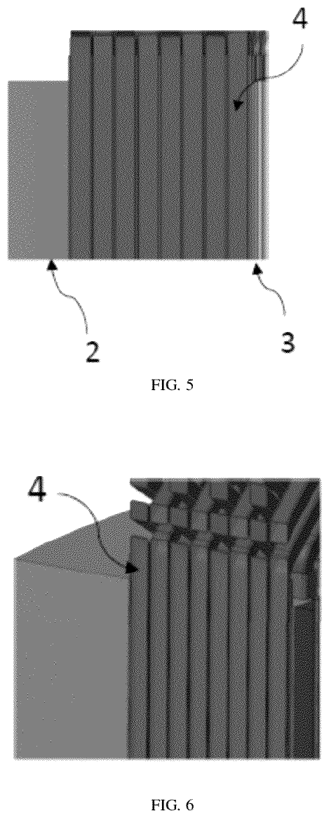

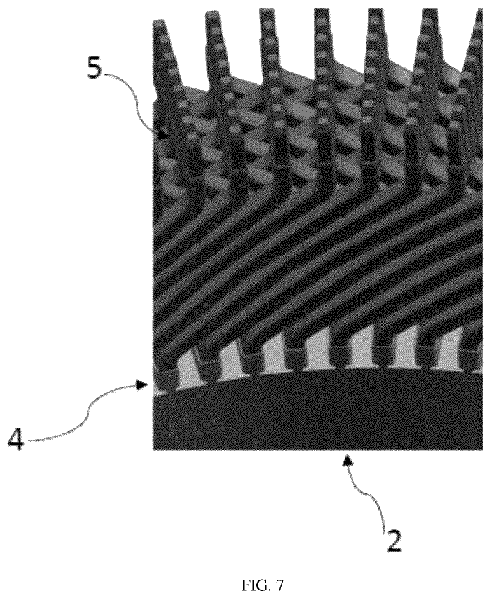

Now referring to FIG. 4 shows a top down view of a portions of the stator body in which copper wires 4 are inserted along the depth of the entire slot. The electrical steel 2 (i.e., teeth in between each slot) can be seen. FIG. 5 shows cross-sectional view of each of the slots where edge 2 is electrical steel, the outer wall of the stator assembly. The copper wires 4 are aligned all along the cavity of the slot, which are separated by mesh 3. FIG. 6 shows top end view of the copper wires 4 which are wound to form distributed winding. FIG. 6 also shows the mesh 3 separating each of the copper wire.

FIG. 7 shows another cross-sectional view of the slots where the outer wall of the stator containing electrical steel 2, the copper wires and the distributed winding 5 of the copper wires is illustrated.

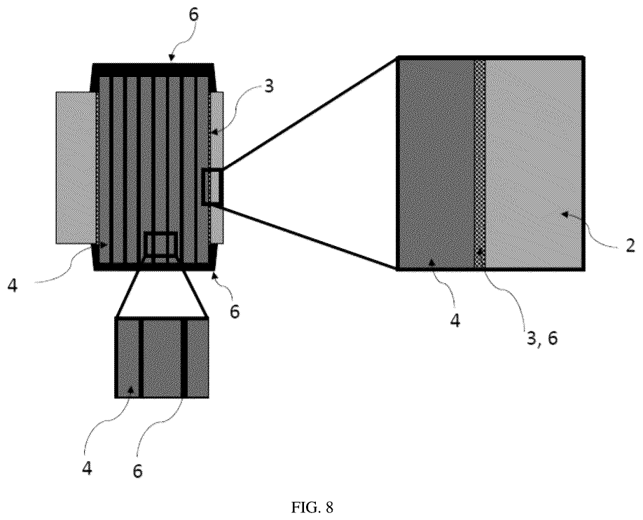

Now referring to FIG. 8, it shows a fully copper wired stator assembly encapsulated with a molding compound 6 of this invention. Also, shown on the right side as well as the bottom of FIG. 8 is an expanded view of the arrangement of the copper wires 4 each of which is separated by a molding compound 6. It is further apparent from the side expanded view is that the outer most copper wire 4 is separated by a mesh which is adjoining to the inner electrical steel 2 wall of the stator assembly. This expanded side view also clearly illustrates that the molding compound 6 has uniformly penetrated the mesh 3. After filling with the molding compound the entire stator assembly was subjected to the conditions of transfer mold to form the stator assembly of this invention.

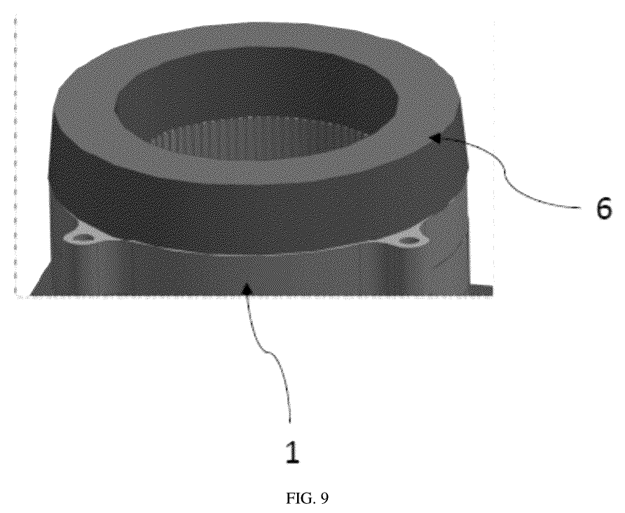

Finally, FIG. 9 shows the stator assembly 1 made in accordance with this invention. The top portion of the stator assembly 1 is fully encapsulated using an epoxy molding compound 6 as described hereinabove.

Accordingly, FIGS. 1 to 9 illustrate how to manufacture a stator assembly of this invention. Additionally, the following series of examples illustrate the “insulation” properties that can be obtained from the practice of this invention.

### Example 1

Various fiber glass mesh sheet as summarized in Table 1 were impregnated on both sides with the molding compound (EME-M200T type NA) by placing a layer of the mesh compound in a suitable die over which was placed the mesh sheet which was again covered with the molding compound. The die was then heated to 175° C. at a molding pressure of 10 ton for about 3 minutes. The die was cooled to room temperature and the mesh impregnated with the molding compound was obtained as a 2″ diameter test specimen of varying thickness as summarized in Table 1. The dielectric strength of each of the impregnated sample was measured in accordance with the procedures as set forth in ASTM D149 using the instrument, Haefely Hipotronics D149 Breakdown Tester, Model No. 7100-5D149-6-B. The dielectric strength of each of the impregnated sample was measured three times and the average of which is noted. The results are summarized in Table 1. Also summarized in Table 1 is the results obtained for molding compound alone as well as fiber glass alone. It is evident from the results presented in Table 1 that fiber glass alone does not contribute to any electrical insulation. It is also evident from the results presented in Table 1 that the molding compound is the sole contributor of electrical insulation. Even more importantly it is interesting to note that even the thinnest sample having the thickness of 0.21 mm exhibits excellent performance of dielectric strength of 9.25 kv.

TABLE 1

| | | Molded Piece | | | | | Dielectric |
|---|---|---|---|---|---|---|---|
| Fiber Glass | Fiber Glass | Thickness | Dielectric Strength (kv) | | | | Strength |
| Grade | Thickness (mm) | (mm) | Test 1 | Test 2 | Test 3 | Av. | (kv/mm) |
| All fiber | | No molding | | | | 0.00 | 0.00 |
| glass sheet | | | | | | | |
| SF | 0.100 | 0.24 | 8.51 | 12.48 | 10.5 | 10.5 | 43.7 |
| 2 oz | 0.070 | 0.35 | 13.41 | 13.5 | 10.5 | 12.47 | 35.6 |
| 4 oz | 0.100 | 0.37 | 13.29 | 15.39 | 13.76 | 14.15 | 38.2 |
| 6 oz | 0.140 | 0.42 | 15.63 | 15.98 | 13.99 | 15.20 | 36.2 |
| YQSDG | 0.015 | 0.21 | 7.23 | 10.61 | 9.91 | 9.25 | 44.0 |
| Ultra Thin | | | | | | | |
| YQSDG | 0.015 | 0.28 | 11.55 | 13.06 | 12.01 | 12.21 | 43.6 |
| Ultra Thin | | | | | | | |
| YQSDG | 0.040 | 0.25 | 12.13 | 9.8 | 11.66 | 11.20 | 44.8 |
| Fabric | | | | | | | |
| YQSDG | 0.040 | 0.37 | 14.81 | 13.06 | 13.88 | 13.92 | 37.6 |
| Fabric | | | | | | | |
| 0.015 × 2 | 0.030 | 0.3 | 16.33 | 13.53 | 13.99 | 14.62 | 48.7 |
| No fiber | 0.000 | 0.41 | | | | 15.05 | 36.7 |
| glass | | | | | | | |
| No fiber | 0.000 | 0.38 | | | | 16.17 | 42.6 |
| glass | | | | | | | |

Although the invention has been illustrated by certain of the preceding examples, it is not to be construed as being limited thereby; but rather, the invention encompasses the generic area as hereinbefore disclosed. Various modifications and embodiments can be made without departing from the spirit and scope thereof.

What is claimed is:

1. A stator assembly comprising:
a plurality of slots across the inner wall of the stator assembly, wherein dispensed a mesh;
a metal wire wound around the fiber mesh forming a coil; and
a molding compound encapsulating the stator assembly.

2. The stator assembly according to claim 1, wherein the mesh is selected from the group consisting of nonwoven mesh, woven mesh, nonwoven plastic mesh, woven plastic mesh, nonwoven glass fabric mesh and woven glass fabric mesh.

3. The stator assembly according to claim 1, wherein there is a gap between the slot and the metal wire of at least about 0.1 mm.

4. The stator assembly according to claim 1, wherein there is a gap between the slot and the metal wire from about 0.1 mm to 0.3 mm.

5. The stator assembly according to claim 1, wherein the mesh is enabling uniform thin wall electrical insulation.

6. The stator assembly according to claim 1, wherein the mesh is enabling uniform minimum thermal path and high thermal conductivity.

7. The stator assembly according to claim 1, wherein the molding compound is selected from the group consisting of epoxy resin, epoxy molding compound, inorganic fillers and mixtures in any combination thereof.

8. The stator assembly according to claim 1, wherein the molding compound has a thermal conductivity K1 of a minimum value of about 0.5 W/mK (to 10 W/mK).

9. The stator assembly according to claim 1, wherein the molding compound exhibits a glass transition temperature (Tg) higher than 150° C.

10. The stator assembly according to claim 1, wherein the molding compound exhibits a compression strength at 25° C. from about 25 kpsi to 40 kpsi.

11. The stator assembly according to claim 1, wherein the thickness of the encapsulated molding resin is from about 0.1 mm to about 3.0 mm.

12. The stator assembly according to claim 1, wherein the inner wall of the assembly consists of an electrical steel with high electromagnetic property.

13. The stator assembly according to claim 1, wherein the inner wall of the assembly consists of a metal alloy with high electromagnetic property.

14. The stator assembly according to claim 1, wherein it enables active cooling on the rotational axis direction side from the coil.

15. The stator assembly according to claim 1, wherein the coil is configured as a distributed winding wound across multiple slots.

16. A high productivity one shot molding method of making a stator assembly comprising:
providing a plurality of slots along the inner diameter of the stator assembly, wherein the slot is a stamped profile;
dispensing within each of the slots a mesh covering the entire surface of the slot;
inserting a progressive winding along the mesh;
forming a winding configuration; and
insulating and encapsulating simultaneously the stator assembly with a molding compound.

17. The method according to claim 16, wherein the stator assembly is made of an electrical steel which is a non-grain-oriented electrical steel containing about 2 percent to about 3.5 percent silicon.

18. The method according to claim 16, wherein the stator assembly is made of a metal alloy electrical steel containing magnesium or aluminum.

19. The method according to claim 16, wherein the mesh is selected from the group consisting of nonwoven mesh, woven mesh, nonwoven plastic mesh, woven plastic mesh, nonwoven glass fabric mesh and woven glass fabric mesh.

20. The method according to claim 16, wherein the molding compound is selected from the group consisting of epoxy molding compound, epoxy resin, inorganic fillers and mixtures in any combination thereof.
